(19) United States
(12) Patent Application Publication
(10) Pub. No.: US 2008/0303248 A1
(43) Pub. Date: Dec. 11, 2008

(54) PORTABLE SHOPPING CART PORT-A-CART

(76) Inventor: Omar Chaparro, Weston, FL (US)

Correspondence Address: OMAR CHAPARRP, 3209 HUNTINGTON, WESTON, FL, 33332, US

(21) Appl. No.: 11/760,786

(22) Filed: Jun. 10, 2007

(51) Int. Cl. B62B 1/00

(52) U.S. Cl. 280/651

(57) ABSTRACT

A portable shopping cart with foldable front legs and retractable back legs that permits the shoppers to easily unload the cart from the back of their Mini-van or SUVS and load it back to the vehicle, filled with groceries, with a minimum effort. The top part is a plastic rectangular basket or container with inside compartments that will permit the proper separation of different types of products so these will be well protected. It also includes some removable containers that fit in some of the compartments and are made of thermal materials to keep the dairy food and fresh food in good condition while is being transported. The basket is mounted on a metallic frame that holds the two sets of legs with wheels. The front of the basket is also equipped with a set of two wheels intended to hold the front of the cart and guide it inside the vehicle while the front legs are folded. The two front legs fold when the cart is pushed inside the vehicle and open when the cart is pulled out of the vehicle. The two back legs are telescopic designed to be retracted inside the basket when the cart is pushed in to the vehicle, and drop down when the cart is pulled out of the vehicle, by a spring mechanism.

This is a shopping cart that has been designed to be easily loaded and transported in the cargo compartment of an SUV or a Mini van. It is conformed by two main parts: the basket and the legs-wheel system. Because of the fact that this cart does not need to be stacked like the traditional shopping carts, the design takes advantage to create a device that properly solves most of the real needs for comfortable shopping, and a lot more appropriate conditions to carry food and groceries in a real convenient fashion.

01. Basket.

The basket is made of plastic, making it easy to be cleaned, and has several different compartments conceived to separate the different types of products in a way that each one occupies a proper space and no damage will be caused by heavy objects over delicate or soft objects. The different compartments are designed to give room to different types of products according to their size, weight and type. This way shoppers don't have to mix heavy soda bottles with fragile cases of eggs, or soft loaves of bread. Some of these compartments will include removable containers made of thermal plastic that are designed to protect and preserve delicate food as dairy products, fish, poultry and meats. These removable containers have lids to better protect and preserve the food. Inside the main basket there is also a foldable seat to permit an infant to be carried with no risk or harm. Inside the basket there is also a small compartment to keep a note pad with shopping list. There is also a locked hook to protect the shopper's purse.

2. Leg-Wheels

The legs-wheel system is made of aluminum to make it light and strong. It has a square frame that holds three pairs of wheels. The first two are located in the front part of the cart, at the bottom of the basket, top of the frame, and are supposed to hold the weigh of the cart on the edge of the vehicle and helps slide the cart to the inside of the vehicle. The second pair is located at the bottom of the front legs. The third pair is located at the bottom of the rear legs. The front two legs fold up to permit the cart to be pushed inside the cart. These legs fold down open to hold the cart at a comfortable height for shopping. These front legs are covered with a rubber padding to protect the bumper and the inside of the vehicle. The two back legs retract inside the basket with a spring mechanism, to permit the complete introduction of the cart inside the back of the vehicle. These two legs fall out down when the cart is pulled back out of the vehicle and the spring mechanism is triggered.

The materials and production are conceived to be produced at a low cost but with great quality and resistance to normal wear.

### BRIEF DESCRIPTION OF THE DRAWINGS

The best way to understand this invention is to analyze the drawings. These will give the observer a clearer view of the idea and how this invention will help the users. Here is a brief description of each one of these drawings:

FIG. 1. Side view of the cart where the folding movement of the front legs is shown, and the rear legs can be observed.

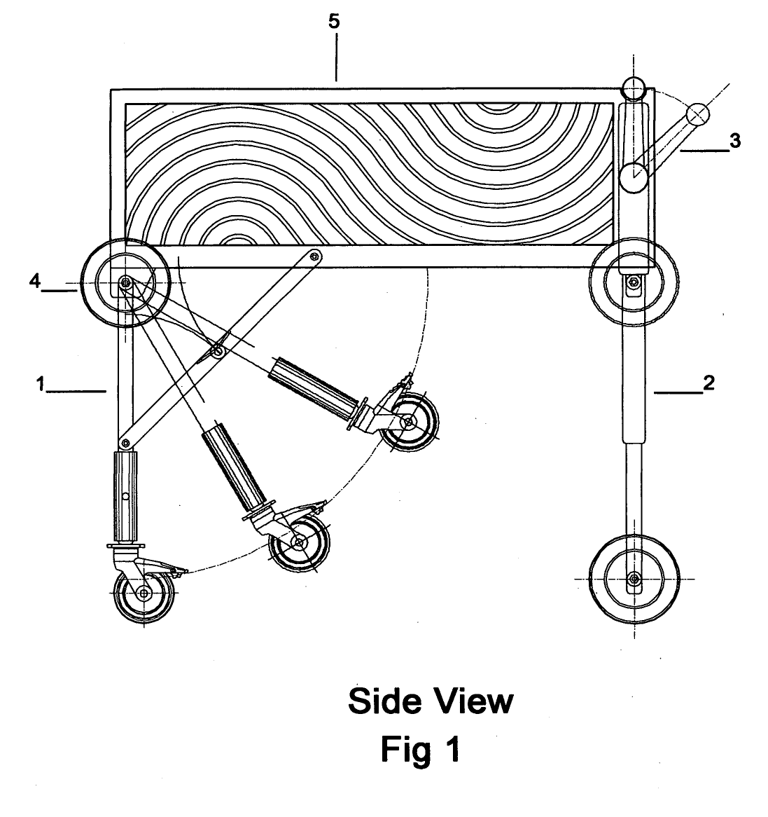

FIG. 2. Front view of the shopping cart.

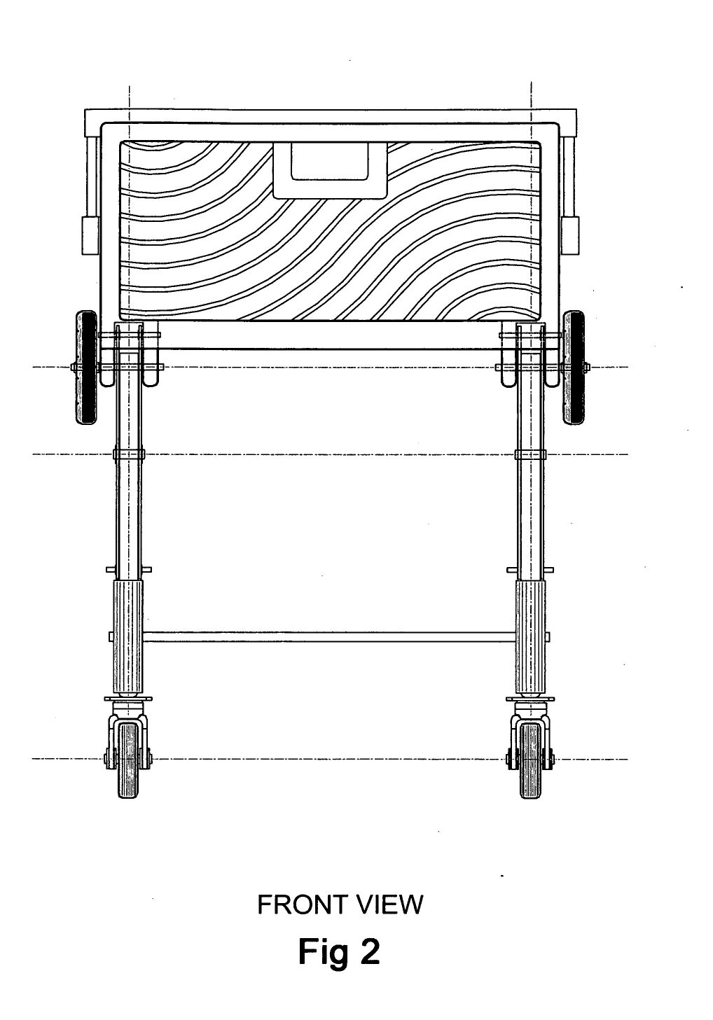

FIG. 3. Rear view of the shopping cart depicting the telescopic mechanism.

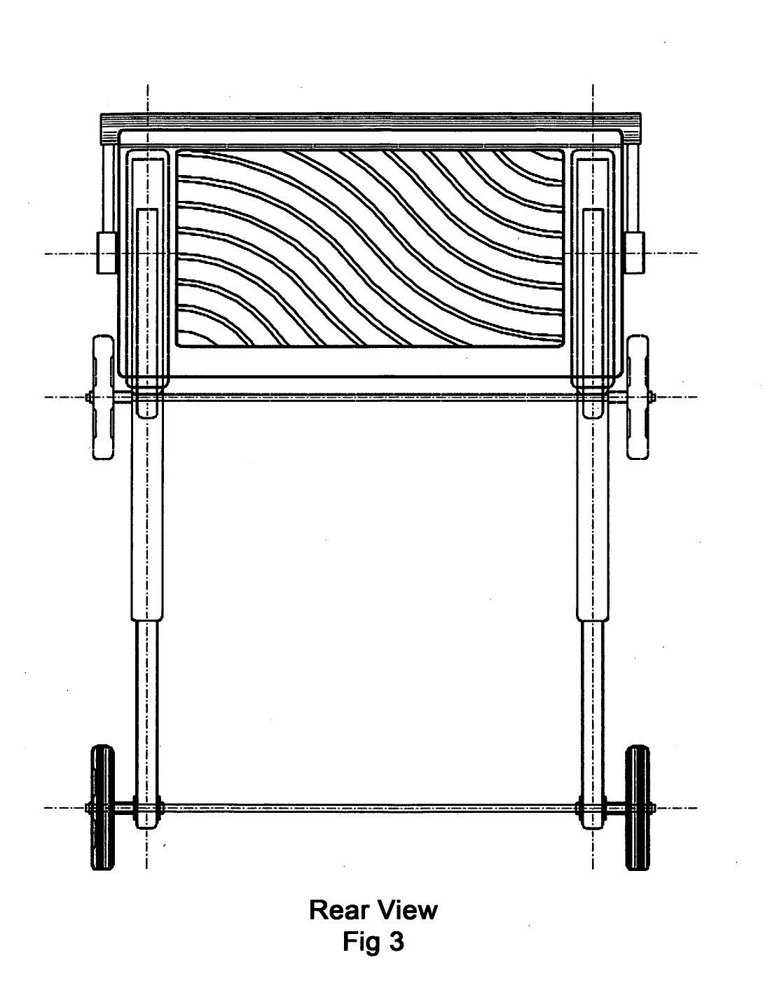

FIG. 4. Top view o the shopping cart.

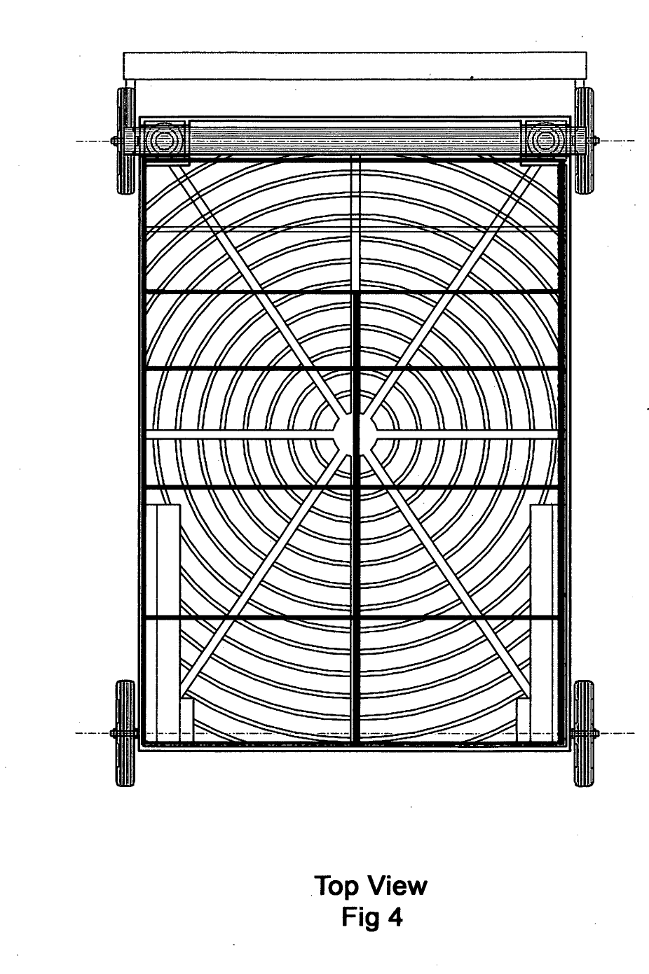

FIG. 5. Three views of the rear legs telescopic mechanism. First with the leg extended, second with the leg half way inside the basket special compartment, and third completely retracted inside the special compartment.

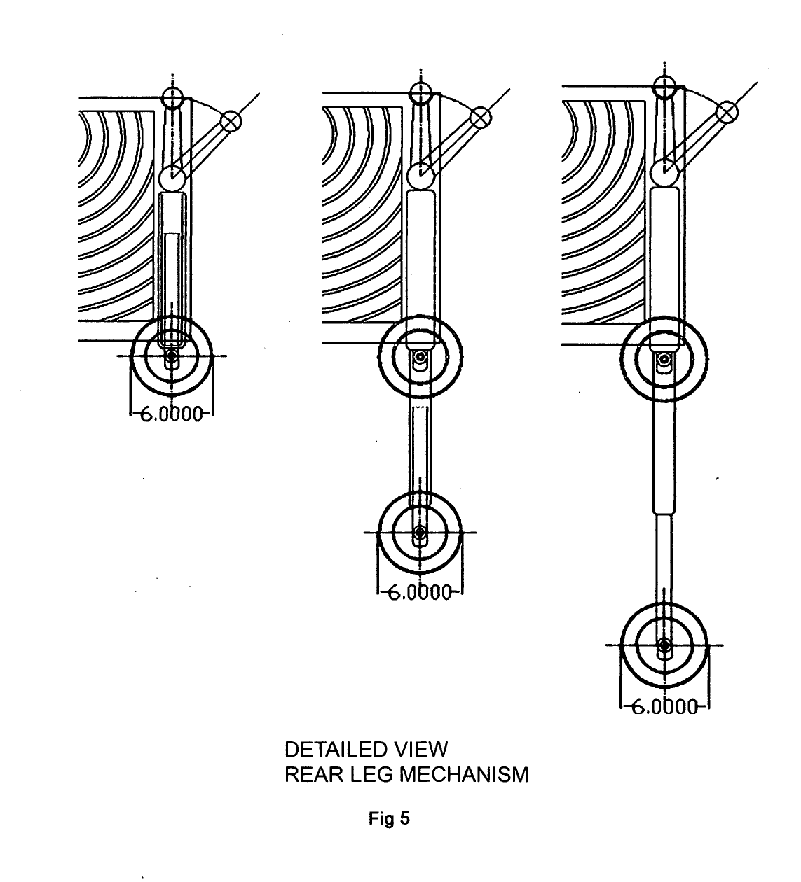

FIG. 6. Diagram of the basket compartments, specifying recommended use.

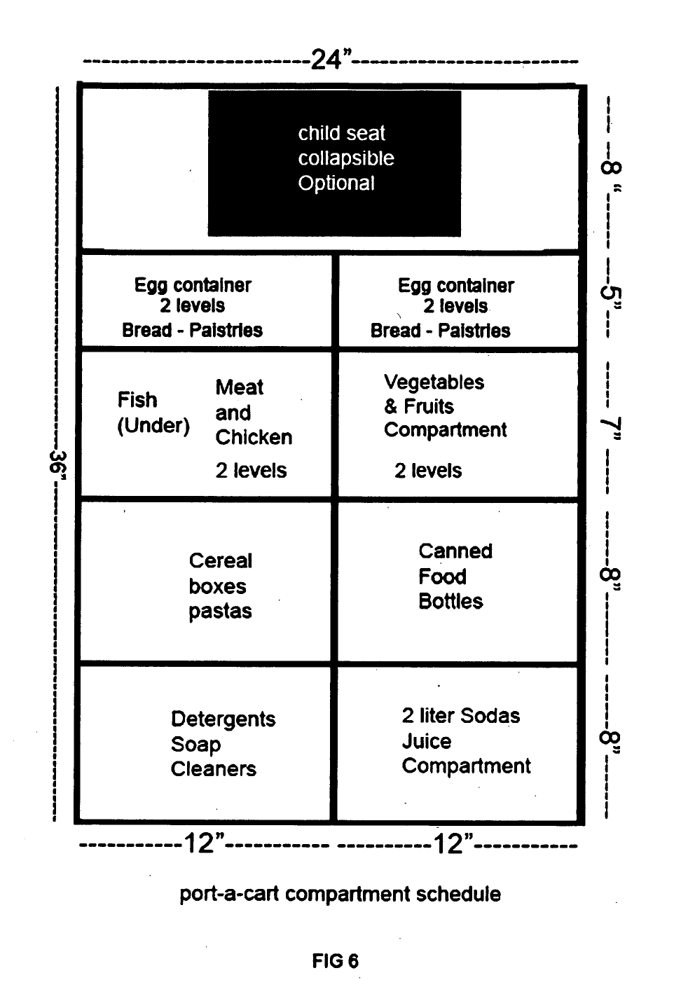

FIG. 7. A perspective of the portable shopping cart.

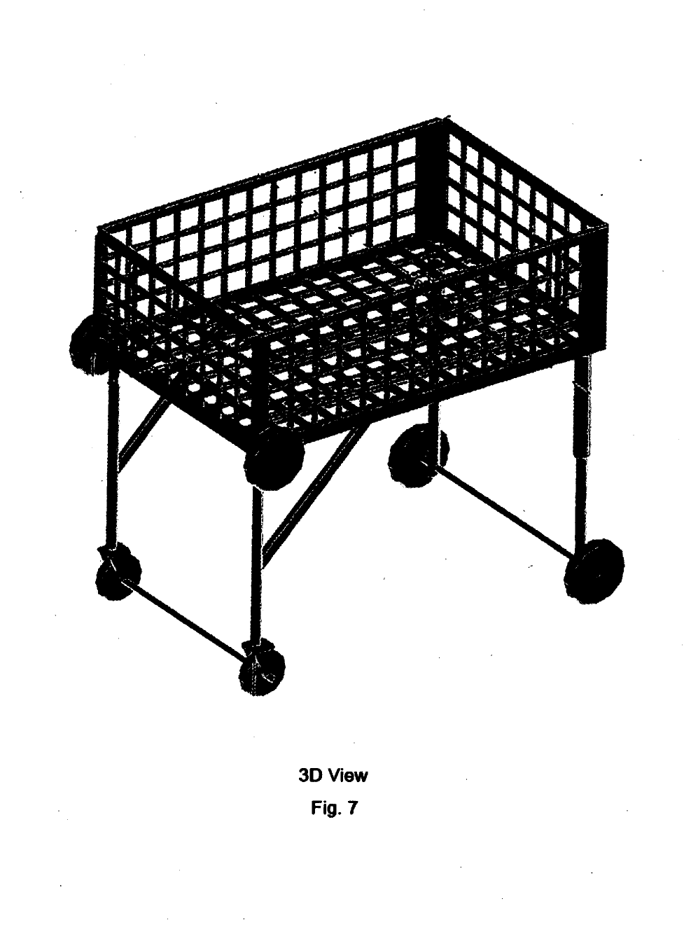

FIG. 8. Side elevation showing the cart ready to be pushed inside the Mini Van.

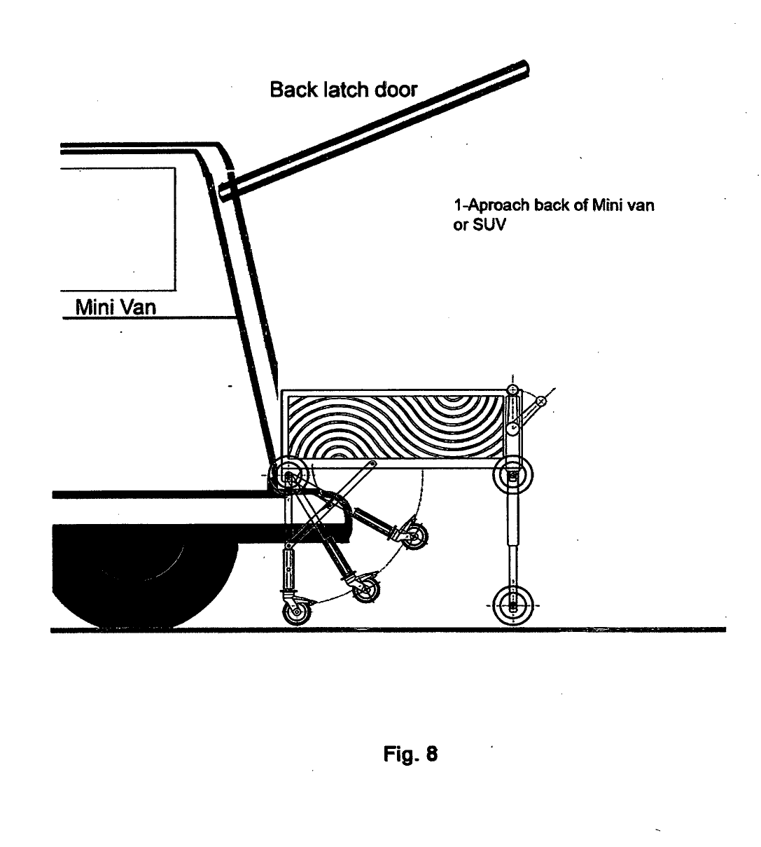

FIG. 9 Side elevation showing the cart half way inside the Mini Van.

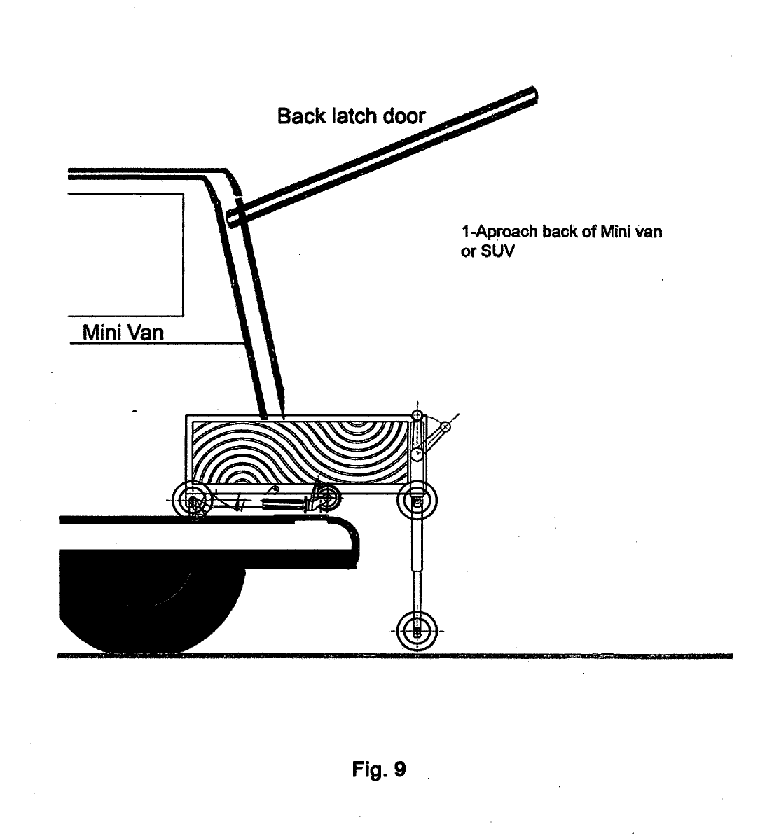

FIG. 10. Side elevation showing the cart completely pushed inside the Mini Van.

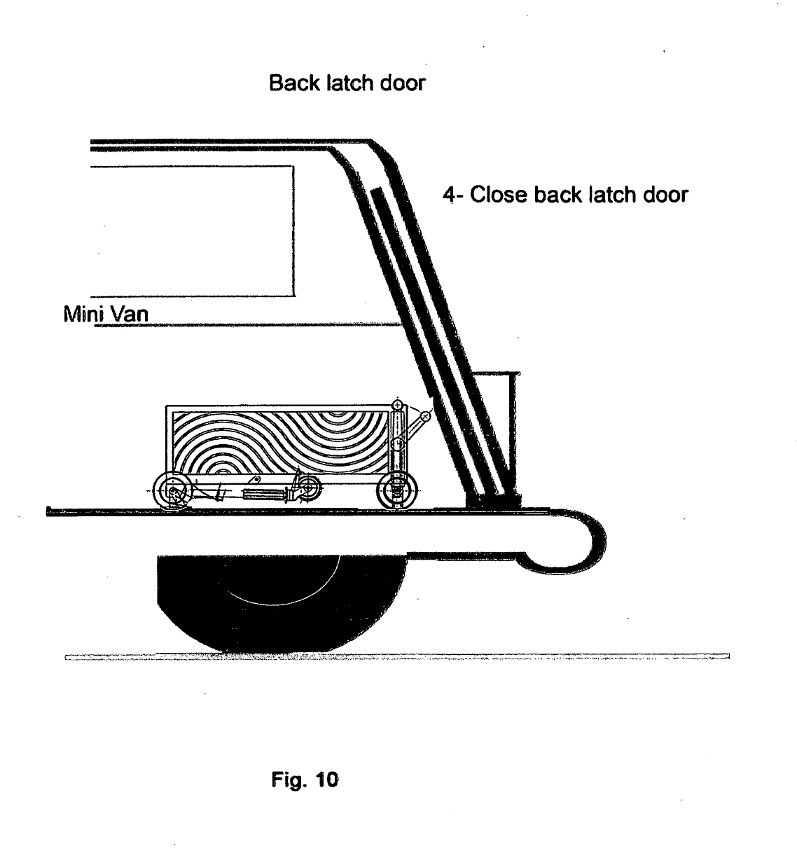

The claim is to the invention of a shopping cart that can be easily transported in an SUV or Mini Van, empty or loaded with groceries, and offers special compartments for different types of foods, and with thermal protection for dairy and fresh foods.

1. This shopping cart has been designed to be carried in the back of an SUV (Sport Utility Vehicle) or a Mini-van, the more used types of vehicles by house wives and super-market shoppers in the US.
The design permits the cart to be loaded to the USV or the Mini van just by pushing it into the back compartment. The front legs 1 of the shopping cart will bend to the back to permit the cart to slide inside the vehicle. The rear legs 2 of the cart are designed to be pulled up by a simple handle 3 so the rest of the cart can go inside the vehicle completely. In the front of the cart there are two wheels 4 that help easy access to the back of the vehicle by letting the front weigh of the cart rest in the bumper and the back of the vehicle. When the shopper pushes the cart inside the vehicle the front legs of the shopping cart will bend and let the cart slide inside of the vehicle.
1—CONVENIENCE. The main purpose of this design is to make grocery shopping a much easier experience by avoiding four times the process of loading and unloading the shopping cart. This way you reduce not only work for the customer at the supermarket, but also the need for so many employees helping pack and load the carts, and then loading the customer's vehicle with groceries. With this portable cart the customer will be able to take the products from the store shelves, load them in to the portable cart, and then taking them directly to the refrigerator or the pantry at home. Shopper will only have to unload the portable cart from his or hers mini van or SUV, go inside the supermarket, load the products in the cart, drive them inside the cart through the scanner system, bring them to the SUV or Mini van and load the cart with the products inside the vehicle.
Then the shopper will simply unload the cart with groceries into the residence and conduct it to the kitchen, refrigerator or pantry for unload. The reduction of work, effort and time are substantial.
Note: the real reduction in work will happen when supermarkets introduce the new Radio Frequency Identification tags (RFID) tags, which consist of silicon chips and an antenna that can transmit data to a wireless receiver. These soon will replace the old bar code system to track everything from soda cans, to cereal boxes.
With this new system in place, shoppers will just push their shopping carts through the cash register station and the total amount of the purchase will be shown at the register without unloading or checking each product at a time.
Other option to optimize this process would be to require all vendors and Manufacturers to place the bar codes in he top part of the products, this way by placing the products upward in the cart will permit the laser scanner to check all items in the cart.
2—SAVINGS. AND ENVIRONMENTAL ADVANTAGES. With the use of this portable shopping cart there is no need for plastic or paper bags, which results not only in a very considerable economy, but also in a huge reduction in pollution. If just 1% one percent of grocery shoppers in America use this cart instead of the traditional one, the reduction in use of shopping bags will be close to 360 million units per year, taking a population of 100 million house holds, consuming about 15 bags twenty four times per year.
SUPER MARKET SAVINGS. With generalized use of these carts the supermarkets swill save millions of dollars in manufacture and maintenance of shopping carts. These savings should be transferred to customers in grocery prices.
3—OTHER FEATURES. Because of the design of special thermal 5 compartments in the portable cart, it will be easy to keep perishable and frozen goods for A longer time in your car, making it possible for shoppers to do other things after shopping. Fragile products like eggs, bread, bottles will be protected form crashing or smashing under the weight of other heavier items.
The compartments are removable, so you can put them in your freezer, pantry or any other place in your home. These are also washable so you can maintain proper hygiene.
4—MATERIALS—It is recommended to use high resistant plastic for the basket and the interior compartments, and stainless steel and aluminum for the support, legs and wheels.
5—The cart will also be equipped with a convenient compartment to hold a grocery list, and a lock to protect a purse or hand bag.
6—One option could be to have a refrigerated cart with an electrical connection to the SUV or Mini Van 12 volt outlet. This, off course, would be a more expensive version.
7—There are many other advantages for the use of this cart that can be assessed by experts in supermarket operators, but mainly by the users: house wives, household heads, and everyone who shops at a store or supermarket.
PRICE: In order to make this cart easy to purchase the sell price should not be higher than $150 per unit. The cost of massive production should not be over $75 Per unit.
Being this a personal property cart it is possible to load it with many other features.

2. ADDITIONAL USES:
These carts can be used for camping and vacations, or week end outings, as a portable cooler, ideal for transporting ice, cold beverages, water, and food.
